(19) United States
(12) Patent Application Publication
(10) Pub. No.: US 2012/0228286 A1
(43) Pub. Date: Sep. 13, 2012

(54) Inductive Heating Device for Aquarium Tanks

(75) Inventors: Thomas R. Lutz, Franklin, WI (US); Andrew S. Hudson, Oak Creek, WI (US)

(73) Assignee: CENTRAL GARDEN AND PET COMPANY, Walnut Creek, CA (US)

(21) Appl. No.: 13/415,964

(22) Filed: Mar. 9, 2012

Related U.S. Application Data
(60) Provisional application No. 61/450,836, filed on Mar. 9, 2011.

(51) Int. Cl. H05B 6/10

(52) U.S. Cl. 219/635

(57) ABSTRACT

Disclosed are heating devices for regulating the temperature of water in an aquarium tank. The devices utilize high frequency inductive heating in order to heat water in the aquarium tank.

### CROSS-REFERENCE TO RELATED APPLICATIONS

The present application claims the benefit of priority under 35 U.S.C. §119(e) to U.S. Provisional Patent Application No. 61/450,836, filed on Mar. 9, 2011, the content of which is incorporated herein by reference.

### BACKGROUND

The field of the invention relates to water heaters for use in aquarium tanks. In particular, the field of the invention relates to inductive water heaters for use in aquarium tanks.

In normal use of an aquarium, it is often necessary to maintain a stable temperature in the aquarium tank water that is higher than the ambient air temperature. Typically, this is achieved by an immersion heater which consists of a resistive heating coil and a thermostatic control system encased inside watertight glass, corrosion resistant metal, or a thermally conductive plastic tube that is submerged in the aquarium. This system, however, may fail if water enters the immersion heater and shorts out the electrical components. This can allow a dangerous electrical current to flow into the aquarium or may cause the heater to overheat the water. In addition, control of the temperature is not precise due to the fact that the resistive heating coil has a lag time between heating up and cooling down which reduces efficiency.

Induction heating involves the creation of eddy currents within a ferromagnetic material when the material is placed near a magnetic field, for example, as generated by an electromagnetic coil through which a high frequency alternating current is passed. The eddy currents thus created cause heat to be emitted from the ferromagnetic material. This type of type of inductive heating has been utilized in a variety of different cook tops where a coil mounted in the cook top is used to heat a cooking vessel or pot made of a ferromagnetic material when the vessel or pot is placed on the cook top. This type of inductive heating is much safer than conventional heating that utilizes a gas flame or an electric resistive heat source where injury can result if the cook top is touched. Also, inductive heating cook tops do not have a long cool down time that is characteristic of electric resistive heat source cook tops.

Inductive heating elements are known in the art. (See, e.g., U.S. Pat. Nos. 7,692,121; 7,423,244; 6,727,482; 6,504,136; 6,153,863; 5,648,008; 5,428,207; 4,453,067; 5,773,799; 5,430,273; 4,638,135; and 3,989,916, the contents of which are incorporated herein by reference in their entireties). To the inventors' knowledge, inductive heating elements have not been previously described or suggested for use in aquarium tanks.

### SUMMARY

Disclosed are heating devices for modulating the temperature water in an aquarium tank. The devices utilize high frequency inductive heating.

The heating devices are mounted on an aquarium tank and typically on a side wall of the aquarium tank. In some embodiment, the heating devices include: (1) a heating element positioned inside the aquarium tank in water in the tank; and (2) an electromagnetic element for inducing heat in the heating element positioned outside the aquarium (e.g., an external coil unit). The heating device may be mounted on a side wall of the aquarium via a magnetic coupling between the heating element and the electromagnetic element. Alternatively, the heating device may be mounted to a side wall of the aquarium via suction cups.

The heating element is comprised of a magnetic material, including but not limited to ferromagnetic material. Because the heating element is positioned in water in the tank, typically the heating element is coated with a corrosion resistant material that is thermally conductive, including but not limited to porcelain.

The electromagnetic element may comprise a coil through which a high frequency alternating electric current is passed. When the high frequency alternating electric current is passed through the coil, the coil creates eddy currents in the heating element which generate heat. Preferably, the heating element is capable of being heated to a temperature of at least 25° C. The electromagnetic element further may include one or more magnets in order to magnetic couple the electromagnetic element and the heating element and mount the device to a side wall of the aquarium. Alternatively, the electromagnetic element and the heating element may be mounted to a side wall of the aquarium via suction cups.

Optionally, the heating device may include a control unit thermostat for monitoring the temperature of water in the aquarium and regulating temperature of the water via turning the electrical current to the electromagnetic element on and off. The device further may comprise a temperature probe for inserting in the water in the aquarium tank, where the temperature probe is connected to the control unit thermostat and transmits temperature information to the control unit thermostat. Based on the temperature information thus transmitted, the control unit thermostat may regulate the electrical current that is supplied to the electromagnetic element.

### BRIEF DESCRIPTION OF THE DRAWINGS

FIG. 1 illustrates one embodiment of a heating device as contemplated herein.

### DETAILED DESCRIPTION

The subject matter disclosed herein is described using several definitions, as set forth below and throughout the application.

Unless otherwise specified or indicated by context, the terms “a,” “an,” and “the,” mean “one or more.” For example, “a heater” should be interpreted to mean “one or more heaters” and “an element” should be interpreted to mean “one or more elements.”

As used herein, the terms “include” and “including” have the same meaning as the terms “comprise” and “comprising.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus of the particular term and “substantially” and “significantly” will mean plus or minus >10% of the particular term.

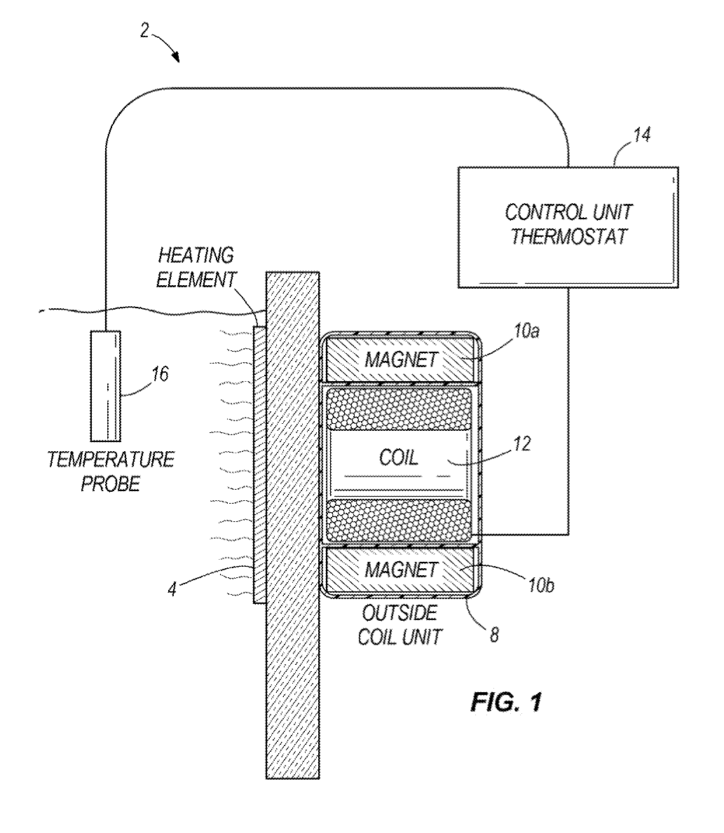

Referring now to FIG. 1, shown is one embodiment of a heating device as contemplated herein 2. The heating device is a through-wall heating system where the heating element 4 is located within the aquarium on the inside of a side wall 6 and the power and control systems are located outside the aquarium and generate high frequency inductive heating. The heating element 4 has an internal surface composed of suitable ferromagnetic material coated with a thermally conductive corrosion resistant material including but not limited to porcelain or thermally conductive plastic material. The heating element 4 is positioned within the aquarium and is aligned with an electromagnetic element, and in particular as shown in FIG. 1, an external coil unit 8 that is located on the outside of the aquarium. In some embodiments, the heating element 4 and the external coil unit 8 are aligned via magnetic coupling of the heating element 4 and the external coil unit 8 through the side wall 6. Optionally, the heating element 4 and/or external coil unit 8 may be mounted to the side wall 6 and aligned via suction cups that attach to the side wall 6.

The external coil unit 8 shown in FIG. 1 includes magnets 10a, 10b and a coil 12 through which a high frequency alternating electric current is passed thereby generating a magnetic field. When the heating element 4 is positioned near the magnetic field, for example, when the heating element 4 and the external coil unit 8 are aligned on opposite sides of the side wall 6, eddy currents are created in the heating element 4 which generate heat. The external coil unit 8 is controlled by a control unit thermostat 14 which monitors the temperature of the aquarium water and regulates the AC power to the coil as necessary. A thermostat probe 16 is located within the aquarium to monitor the water temperature and to supply temperature information to the control unit thermostat 14 which regulates power to the external coil unit 8 based on the temperature information.

The disclosed devices are advantageous over conventional heating devices that utilize resistive heating elements. First, the disclosed heating devices do not pass an electric current into the aquarium tank making the device much safer to use. In addition, the disclosed heating devices utilize a magnetically coupled heating element that is much smaller than convention resistive heating devices, which improves the aesthetics of the aquarium. Furthermore, the disclosed heating devices can be positioned and moved anywhere along the glass side wall of an aquarium easily. Finally, in the disclosed heating devices, temperature control is more precise than Conventional resistive heating devices because inductive heating has a decreased cooling/heating lag-time relative to the cooling/heating lag-time for resistive heating.

It will be readily apparent to one skilled in the art that varying substitutions and modifications may be made to the invention disclosed herein without departing from the scope and spirit of the invention. The invention illustratively described herein suitably may be practiced in the absence of any element or elements, limitation or limitations which is not specifically disclosed herein. The terms and expressions which have been employed are used as terms of description and not of limitation, and there is no intention in the use of such terms and expressions of excluding any equivalents of the features shown and described or portions thereof, but it is recognized that various modifications are possible within the scope of the invention. Thus, it should be understood that although the present invention has been illustrated by specific embodiments and optional features, modification and/or variation of the concepts herein disclosed may be resorted to by those skilled in the art, and that such modifications and variations are considered to be within the scope of this invention.

Citations to a number of patent and non-patent references are made herein. The cited references are incorporated by reference herein in their entireties. In the event that there is an inconsistency between a definition of a term in the specification as compared to a definition of the term in a cited reference, the term should be interpreted based on the definition in the specification.

What is claimed is:

1. An inductive heating device for mounting on an aquarium tank.

2. The device of claim 1, wherein the device comprises a heating element positioned inside the aquarium tank in water in the tank and an electromagnetic element for inducing heat in the heating element positioned outside the aquarium tank.

3. The device of claim 1, wherein the device is mounted on a side wall of the aquarium via a magnetic coupling between the heating element and the electromagnetic element.

4. The device of claim 1, wherein the heating element comprises a material capable of being heated by induction heating that is coated with a thermally conductive corrosion resistant material.

5. The device of claim 4, wherein the heating element comprises ferromagnetic material coated with porcelain.

6. The device of claim 2, wherein the electromagnetic element comprises one or more magnets and a coil through which a high frequency alternating electric current is passed.

7. The device of claim 6, wherein when the high frequency alternating electric current is passed through the coil of the electromagnetic element, eddy currents are created in the heating element which generate heat.

8. The device of claim 7, further comprising a thermostat for monitoring the temperature of the water in the aquarium and for turning the alternating electrical current on and off in order to regulate the temperature of the water in the aquarium.

9. The device of claim 8, further comprising a probe for monitoring the temperature of the water in the aquarium.

10. An inductive heating device for mounting on an aquarium tank, wherein the device is capable of heating water in the aquarium to a temperature of at least about 25° C.

11. The device of claim 10, wherein the device comprises a heating element positioned inside the aquarium tank in water in the tank and an electromagnetic element for inducing heat in the heating element positioned inside the aquarium tank.

12. The device of claim 11, wherein the device is mounted on a side wall of the aquarium via a magnetic coupling between the heating element and the electromagnetic element.

13. The device of claim 11, wherein the heating element comprises a material capable of being heated by induction heating that is coated with a thermally conductive corrosion resistant material.

14. The device of claim 13, wherein the heating element comprises ferromagnetic material coated with porcelain.

15. The device of claim 11, wherein the electromagnetic element comprises one or more magnets and a coil through which a high frequency alternating electric current is passed.

16. The device of claim 15, wherein when the high frequency alternating electric current is passed through the coil of the electromagnetic element, eddy currents are created in the heating element which generate heat.

17. The device of claim 16, further comprising a thermostat for monitoring the temperature of the water in the aquarium and for turning the electrical current on and off in order to regulate the temperature of the water in the aquarium.

18. The device of claim 17, further comprising a probe for monitoring the temperature of the water in the aquarium.
